(19) United States
(12) Patent Application Publication
(10) Pub. No.: US 2014/0096841 A1
(43) Pub. Date: Apr. 10, 2014

(54) ANTI-SURGE VALVE FOR VEHICLE

(71) Applicants: HYUNDAI MOTOR COMPANY, Seoul (KR); KIA MOTORS CORPORATION, Seoul (KR)

(72) Inventors: Sung Hyun IM, Hwaseong-si (KR); Young Soo JIN, Hwaseong-si (KR); Kyung Woo LEE, Hwaseong-si (KR)

(73) Assignees: Kia Motors Corporation, Seoul (KR); Hyundai Motor Company, Seoul (KR)

(21) Appl. No.: 13/690,908

(22) Filed: Nov. 30, 2012

(30) Foreign Application Priority Data
Oct. 10, 2012 (KR) 10-2012-0112574

(51) Int. Cl. F16K 7/00

(52) U.S. Cl. CPC F16K 7/00
USPC 137/315.01

(57) ABSTRACT

An anti-surge valve includes a diaphragm partitioning an internal space formed by a valve body and a cover into spaces in which a pressure chamber connected to a connection port, an air inlet and an air outlet are formed; a valve cup assembled to the diaphragm; a coupling member that fixes the diaphragm and the valve cup; and a spring that elastically supports the diaphragm in the pressure chamber. In the anti-surge valve, a side wall of the valve cup has a sectional shape concave toward the center of the valve along the entire circumference thereof so that a side portion of the diaphragm is deformed toward the center of the valve while being adhered closely to an outer surface of the side wall of the valve cup in a state in which an edge portion of the diaphragm is fixed by the valve body and the cover.

### CROSS-REFERENCE TO RELATED APPLICATION

The present application claims priority of Korean Patent Application Number 10-2012-0112574 filed Oct. 10, 2012, the entire contents of which application is incorporated herein for all purposes by this reference.

### BACKGROUND OF INVENTION

1. Field of Invention

The present invention relates to an anti-surge valve for a vehicle. More particularly, the present invention relates to an anti-surge valve for a vehicle, which can prevent damage of a diaphragm due to stress concentration under operation and prevent a phenomenon of engine disorder and power shortage due to the damage of the diaphragm during vehicle operation.

2. Background Art

In general, a turbocharger for supercharging intake air supplied to an intake manifold is mounted in a compressed natural gas (CNG) engine using CNG as fuel. The turbocharger has a configuration including a compressor and a turbine coaxially connected to each other.

In the turbocharger, the compressor is connected to an intake line, and the turbine is connected to an exhaust line. If the turbine is rotated by the pressure of exhaust gas exhausted from the engine through the exhaust line, the compressor coaxially connected to the turbine so as to be rotated together is rotated, thereby supercharging the intake air passing through the intake line.

The air supercharged by the compressor of the turbocharger is generally cooled while passing through an intercooler and then flowed in the intake manifold when a throttle valve is opened. The CNG engine controls power of the engine by controlling the amount of the air supercharged by the turbocharger.

Before the supercharged air is flowed in the intake manifold, the amount of air flowed in the intake manifold is controlled by controlling opening and closing rates of the throttle valve according to a signal of an accelerator pedal, and the final power of the engine is controlled together.

However, in the CNG engine, the flow of air through the throttle valve is temporarily blocked in a section in which power is rapidly decreased after acceleration, e.g., when the throttle valve is closed as a driver does not press the accelerator pedal, but the rotation of the compressor cannot be stopped. Hence, a sudden pressure rise is generated between the turbocharger and the throttle valve.

As the flow of air flowed in the intake manifold is temporarily blocked by the throttle valve, the air of which flow is suddenly blocked at the front end of the throttle valve forms a pulse-wave. Therefore, the pulse-wave gives a great impact on the intercooler and the compressor of the turbocharger.

The sudden pressure rise generated at the front end of the throttle valve by blocking the flow of the air gives a great impact on the compressor of the turbocharger, and therefore, disproportion occurs at a shaft portion of the compressor. In a serious case, wheels of the compressor may be damaged.

Further, surge noise occurs due to the pressure rise and the pulse-wave. The surge noise temporarily occurs when the state of the engine is changed into a non-load state after acceleration of the engine. In this case, the surge noise is considerably high-pitched, and therefore, the level of the surge noise is a level at which the driver can recognize the surge noise.

Therefore, to solve such a problem, an anti-surge valve is mounted, which circulates air to the front of a compressor of the turbocharger through a bypass pipe when a throttle valve is suddenly closed, so that it is possible to minimize the pressure rise and the occurrence of a pulse-wave and to prevent the damage of components and the occurrence of surge noise.

Korean Patent Application Publication No. 2007-40885 is disclosed as a prior patent document related to such an anti-surge valve.

Meanwhile, an anti-surge valve having a valve cup has recently been used. FIG. 1 is a view illustrating a state in which a conventional anti-surge valve is mounted. FIG. 2 is a cut-away perspective view illustrating an internal configuration of the conventional anti-surge valve.

In FIG. 1, reference numeral 2 denotes a throttle body including a throttle valve.

In a CNG engine in which air supercharged by a compressor of a turbocharger mounted to an intake line is flowed in an intake manifold through a throttle valve, the anti-surge valve 100 is mounted to a bypass pipe 3 connected from the entrance front of the compressor of the turbocharger, i.e., the intake line at the front of the compressor. The bypass pipe 3 and the anti-surge valve 100 are mounted to connect between an intake line 1 at the front of the throttle valve and the intake line at the front end of the compressor of the turbocharger.

Particularly, the anti-surge valve 100 controls the flow of air through the bypass pipe 3. Thus, the anti-surge valve 100 prevents the flow of air from being blocked by the throttle valve by opening a flow path through the bypass pipe 3 when the throttle valve is suddenly closed.

That is, if the air pressure at the front end of the throttle valve rises as the throttle valve is suddenly closed, the anti-surge valve 100 performs an opening operation (opens the flow path in the valve), and accordingly, the front end of the throttle valve and the front end of the compressor are communicated with each other through the bypass pipe 3 and the anti-surge valve 100.

As a result, the air passing through the compressor of the turbocharger is flowed in the anti-surge valve 100 from the intake line 1 at the front end of the throttle valve and then re-circulated to the intake line at the front end of the compressor through the bypass pipe 3. Accordingly, it is possible to reduce the sudden pressure rise at the front end of the throttle valve and the generation of the pulse-wave, thereby preventing the damage of the compressor and the occurrence of surge noise.

Referring to FIG. 2, the anti-surge valve 100 includes a valve body 110 and a cover 111, which form a valve internal space in the state in which the valve body 110 and the cover 111 are assembled to each other. An air inlet 113 and an air outlet 114 are formed at side and lower portions of the valve body 110, respectively.

The anti-surge valve 100 is mounted so that the air inlet 113 is connected to the intake line (1 of FIG. 1) at the front end of the throttle valve by a mounting portion 115. The bypass pipe (3 of FIG. 1) is connected to the air outlet 114 so that the air outlet 114 is connected to the intake line at the front end of the compressor through the bypass pipe.

A connection port 112 is formed at an upper portion of the cover 111, and a pressure detection line (4 of FIG. 1) communicated with the intake manifold is connected to the connection port 112.

In addition, the anti-surge valve 100 further includes a diaphragm 120 mounted in a transverse direction to partition the valve internal space formed by the valve body 110 and the cover 111 into spaces in which a pressure chamber 116 to which the connection port 112 is connected, the air inlet 113 and the air outlet 114 are formed, respectively, a valve cup 130 assembled to support the diaphragm 120, coupling members 141 and 142 assembled to each other at upper and lower positions of the central portion of the diaphragm 120 and the valve cup 130 so as to fix the diaphragm 120 to the valve cup 130, and a spring 150 that elastically supports the diaphragm 120 in the pressure chamber 116.

In the anti-surge valve 100 configured as described above, the cover 111 is coupled to the valve body 110 while fixing an edge portion of the diaphragm 120. In this case, the edge portion of the diaphragm 120 is fixed in the state in which the edge portion is friction-welded between the upper end portion of the valve body 110 and the lower end portion of the cover 111, which become a coupling portion between the valve body 110 and the cover 111 so that the diaphragm 120 does not depart in the valve internal space (See FIG. 3).

Hereinafter, an operation state of the anti-surge valve will be described with reference to FIG. 3.

The diaphragm 120 formed to partition the valve internal space into the pressure chamber 116 is operated according to a pressure formed in the pressure chamber 116. In this case, the inside of the intake manifold is in the constant pressure state as the front end of the throttle valve while the throttle valve is opened so that air is flowed in the intake manifold. Therefore, the inside of the pressure chamber 116 connected to the intake manifold through the pressure detection line (4 of FIG. 1) connected to the connection port 112 is also in the constant pressure state so as to maintain the same pressure state as another inside in the valve.

Thus, the diaphragm 120 is pressed by the force of the spring 150 so as to close the air outlet 114. As the air outlet 114 is closed, the flow path in the valve is in a closed state so that both the air inlet 113 and the air outlet 114 are in the closed state (See FIG. 3(b)).

However, if a negative pressure is instantaneously formed in the inside of the intake manifold as the throttle valve is closed, the air in the pressure chamber 116 is sucked into the intake manifold by the negative pressure formed in the pressure detection line 4, and therefore, the inside of the pressure chamber 116 upside the diaphragm 120 is also in the negative state.

In this case, the pressure of the front end of the throttle valve connected to the air inlet 113 is applied to the bottom surface of the diaphragm 120, and hence the diaphragm 120 is lifted beyond the force of the spring 150 by a difference in pressure between the upper and lower sides of the diaphragm 120 (between the inside and outside of the pressure chamber). Accordingly, as the air outlet 114 blocked by the diaphragm 120 is opened, the air path through the air inlet 113 and the air outlet 114, i.e., the flow path in the inside of the valve is also opened (See FIG. 3(c)).

As a result, as the air inlet 113 and the air outlet 114 are communicated with each other, the air at the front end of the throttle valve is re-circulated to the intake line at the front end of the compressor of the turbocharger via the air inlet 113, the air outlet 114 and the bypass pipe (3 of FIG. 1). Accordingly, it is possible to minimize the pressure rise and the generation of the pulse-wave.

Meanwhile, problems of the conventional anti-surge valve will be described as follows.

FIG. 3(a) shows a state in which the anti-surge valve 100 is assembled, and FIG. 3(b) shows a state before the anti-surge valve 100 is opened, i.e., a state before the internal path is opened (a state in which back pressure is applied before the diaphragm and the valve cup move, stroke: 0 mm). FIG. 3(c) shows a state a state after the anti-surge valve 100 is opened, i.e., a state in which the internal path is opened (a state in which the air inlet and the air outlet are communicated with each other so that air can flow through the air inlet and the air outlet).

In FIG. 3(a), there is shown a stroke of the diaphragm 120 in the anti-surge valve 100, and a portion at which damage of the diaphragm 120 frequently occurs is designated by circle A.

First, the conventional anti-surge valve has a structure in which the side wall of the valve cup 130 is vertically extended upward from the bottom portion of the valve cup 130. When the back pressure is applied to the diaphragm 120 as shown in FIGS. 3(a) and 3(b), the diaphragm 120 is adhered closely to the side wall of the valve cup 130.

More specifically, as shown in FIG. 3(b), if the back pressure provided through the air inlet 113 from the front end of the throttle valve is applied to the diaphragm 120 made of a rubber material in the state before the valve is opened, the diaphragm 120 is supported by being adhered closely to the side wall of the valve cup 130.

In this case, the portion A immediately inside from the edge portion diaphragm 120, positioned in a lateral direction, is in a curved state, and therefore, the other portions of the diaphragm 120 are adhered closely to the valve cup 130.

Subsequently, as shown in FIG. 3(c), if the diaphragm 120 is lifted, the back pressure is reduced in the valve is opened. However, an upper end (designated by circle A′) of the side portion of the diaphragm 120 is suddenly curved downward due to the portion adhered closely to the valve cup 130, and simultaneously, the portion A immediately inside from the edge portion of the diaphragm 120 is excessively deformed upward.

An excessive stress is concentrated on the portion A immediately inside from the edge portion of the diaphragm 120 due to the excessive deformation. In this case, as the stress of the portion A is considerably increased as compared with that in the state of FIG. 3(b), the diaphragm 120 made of the rubber material may be torn at the portion A.

That is, when the anti-surge valve 100 is operated in the opened state so that the internal path is opened during driving of a vehicle, the excessive deformation occurs in which the diaphragm 120 is suddenly curved at the portion A immediately inside from the edge portion. As a result, the diaphragm 120 is torn at the portion A on which the stress is concentrated.

In a case where the diaphragm of the anti-surge valve is torn during the driving of the vehicle, the phenomenon of engine disorder and power shortage occurs. Therefore, it is required to provide a plan which can prevent such a phenomenon that the diaphragm is torn and improve durability of the valve.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art. Various aspects of the present invention provide for an anti-surge valve for a vehicle, which can prevent damage of a diaphragm due to stress concentration under operation and prevent a phenomenon of engine disorder and power shortage due to the damage of the diaphragm during driving of the vehicle.

Various aspects of the present invention provide for an anti-surge valve for a vehicle includes: a diaphragm that partitions an internal space formed by a valve body and a cover into spaces in which a pressure chamber connected to a connection port, an air inlet and an air outlet are formed, respectively; a valve cup assembled to the diaphragm; a coupling member that fixes the diaphragm and the valve cup; and a spring that elastically supports the diaphragm in the pressure chamber, wherein a side wall of the valve cup has a sectional shape concave toward the center of the valve along the entire circumference thereof so that a side portion of the diaphragm is deformed toward the center of the valve while being adhered closely to an outer surface of the side wall of the valve cup in a state in which an edge portion of the diaphragm is fixed by the valve body and the cover.

The outer surface of the side wall of the valve cup may be formed to have a curved surface concavely recessed toward the center of the valve.

The side wall of the valve cup may have an arc sectional shape.

In the anti-surge valve for the vehicle according to the present invention, the shape of the side wall of the valve cup is changed into a curved shape having an arc-type section, so that it is possible to reduce a stress concentrated on a specific portion of the diaphragm under an operation of the valve. Accordingly, it is possible to prevent damage of the diaphragm and to improve durability of the valve. As a result, it is possible to solve a problem in that the power of the engine becomes deficient due to the damage of the diaphragm during driving of the vehicle.

The present methods and apparatuses have other features and advantages apparent from the accompanying drawings, incorporated herein, and below Detailed Description, which together serve to explain certain principles of the present invention.

### BRIEF DESCRIPTION OF THE DRAWINGS

FIG. 1 is a view illustrating a state in which a conventional anti-surge valve is mounted.

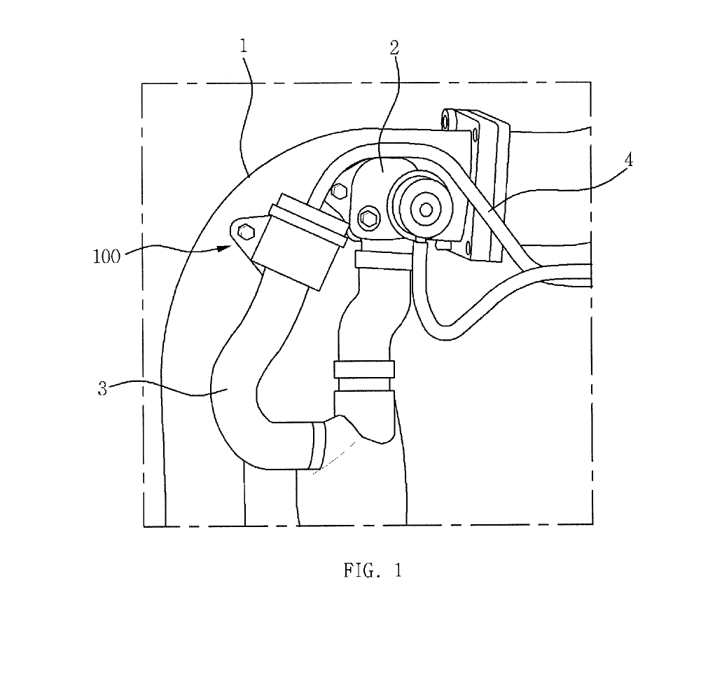

FIG. 2 is a cut-away perspective view illustrating an internal configuration of the conventional anti-surge valve.

FIG. 3 is a sectional view illustrating an operation state of the conventional anti-surge valve and problems of the conventional anti-surge valve.

FIG. 4 is a sectional view illustrating an exemplary anti-surge valve according to the present invention.

FIG. 5 is a sectional view illustrating a state in which a diaphragm is deformed under the opening operation an exemplary the anti-surge valve according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

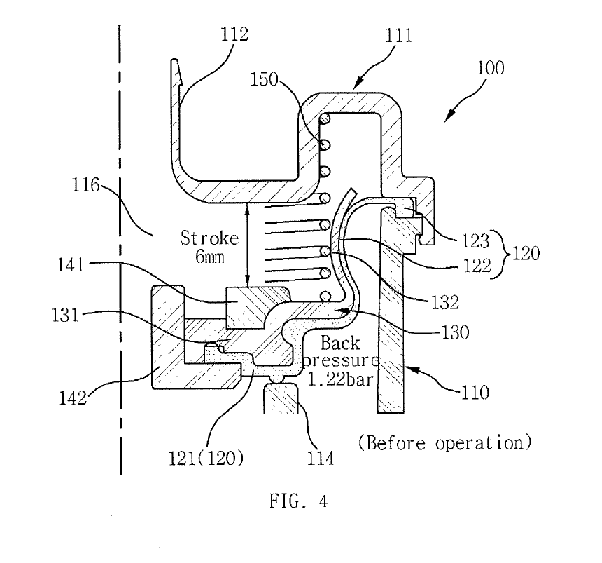

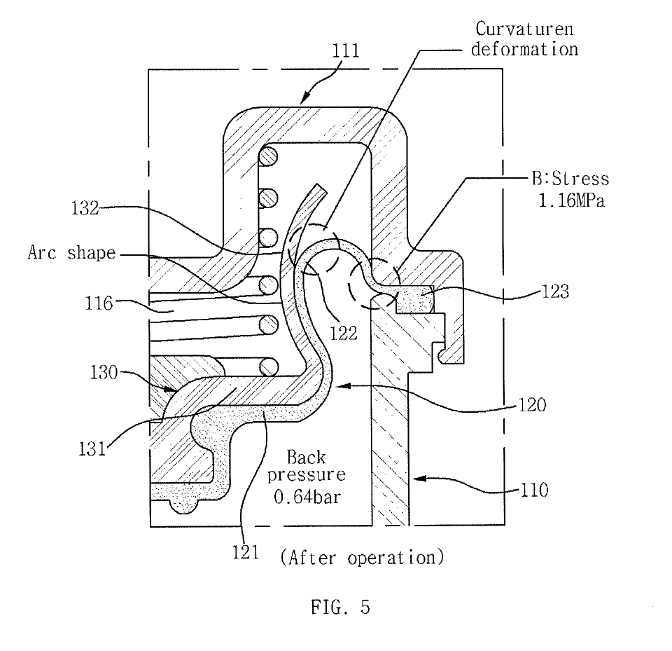

FIG. 4 is a sectional view illustrating an anti-surge valve according to various embodiments of the present invention. FIG. 5 is a sectional view illustrating a state in which a diaphragm is deformed under the opening operation of the anti-surge valve according to various embodiments of the present invention.

To solve the conventional problem in that the damage of the diaphragm occurs due to the excessive deformation and stress concentration, in the anti-surge valve according to various embodiments of the present invention, the stroke of the assembly of the diaphragm and the valve cup is reduced, and simultaneously, the shape of the side wall of the valve cup is changed, so that it is possible to minimize excessive deformation and stress concentration that occur in a specific portion of the diaphragm and to improve durability of the diaphragm and the entire valve.

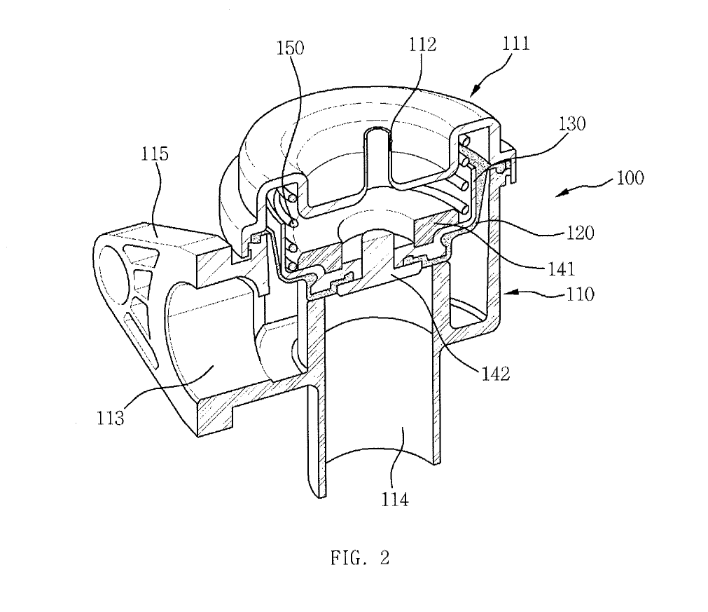

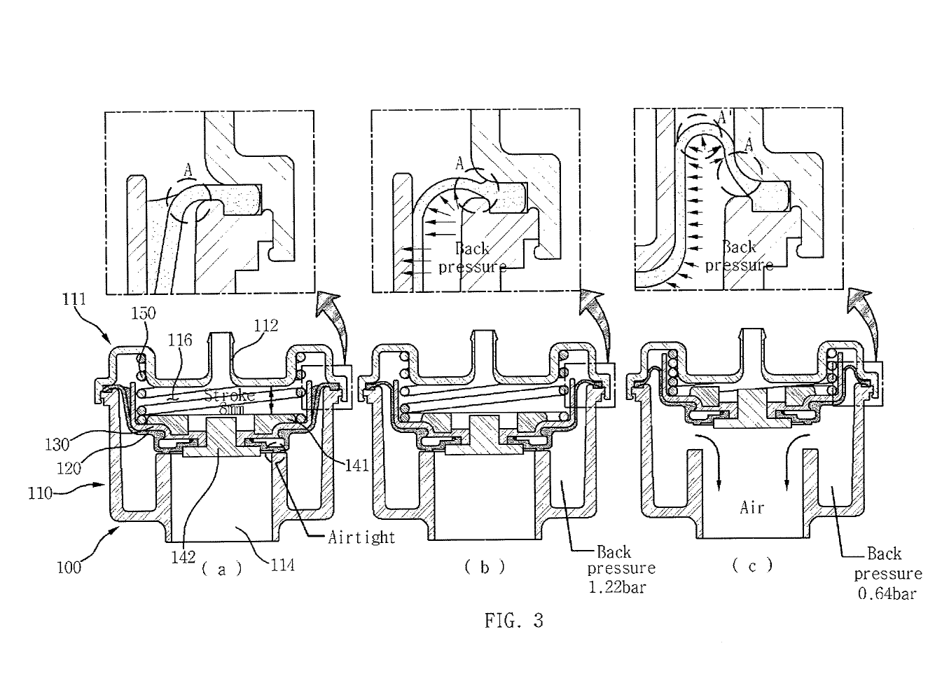

The basic configuration of the anti-surge valve according to various embodiments of the present invention has no difference as compared with the conventional valve shown in FIGS. 2 and 3. However, in the anti-surge valve according to various embodiments of the present invention, the shape of the valve cup is modified in order to improve the durability of the diaphragm.

First, the basic configuration will be described (See FIGS. 2 and 3). The anti-surge valve 100 according to various embodiments of the present invention includes a valve body 110 and a cover 111, which form a valve internal space in the state in which the valve body 110 and the cover 111 are assembled to each other. An air inlet 113 and an air outlet 114 are formed at side and lower portions of the valve body 110, respectively.

The anti-surge valve 100 according to various embodiments of the present invention is mounted so that the air inlet 113 is connected to an intake line at the front end of a throttle valve by a mounting portion 115. A bypass pipe is connected to the air outlet 114 so that the air outlet 114 is connected to the intake line at the front end of a compressor through the bypass pipe.

A connection port 112 is formed at an upper portion of the cover 111, and a pressure detection line communicated with an intake manifold is connected to the connection port 112.

In addition, the anti-surge valve 100 according to various embodiments of the present invention further includes a diaphragm 120 mounted in a transverse direction to partition the valve internal space formed by the valve body 110 and the cover 111 into spaces in which a pressure chamber 116 to which the connection port 112 is connected, the air inlet 113 and the air outlet 114 are formed, respectively, a valve cup 130 assembled to support the diaphragm 120, coupling members 141 and 142 assembled to each other at upper and lower positions of the central portion of the diaphragm 120 and the valve cup 130 so as to fix the diaphragm 120 to the valve cup 130, and a spring 150 that elastically supports the diaphragm 120 in the pressure chamber 116.

In the anti-surge valve 100 configured as described above, the cover 111 is coupled to the valve body 110 while fixing an edge portion 123 of the diaphragm 120 as shown in FIG. 4. In this case, the edge portion of the diaphragm 120 is fixed in the state in which the edge portion is friction-welded between the upper end portion of the valve body 110 and the lower end portion of the cover 111, which become a coupling portion between the valve body 110 and the cover 111 so that the diaphragm 120 does not depart in the valve internal space.

Meanwhile, the valve cup 130 is configured to include a bottom portion 131 that is a portion coupled to the diaphragm 120 by the coupling members 141 and 142, and a side wall 132 extended upward to form a cup-shaped side wall along the entire circumference of the bottom portion 131. In this case, the side wall 132 is formed in a circular shape along the circumference of the cup-shaped side wall.

Accordingly, the valve cup 130 is formed in a cup shape having the circular side wall. Here, the outer surface of the cup-shaped valve cup 130 becomes a surface by which the diaphragm 120 made of a rubber material is adhered and supported.

The entire portion of the diaphragm 120 is also divided, by the cup-shaped valve cup 130, into a bottom portion 121 adhered closely to an outer surface (bottom surface in this figure) of the bottom portion 131 of the valve cup 130 and a side portion 122 adhered closely to an outer surface of the side wall 132 of the valve cup 130. In this case, the edge portion 123 of the diaphragm 120 is fixed in the state in which the edge portion 123 is friction-welded between the valve body 110 and the cover 111.

In the structure described above, the side portion 122 connecting between the bottom portion 121 and the edge portion 123 of the diaphragm 120 has a structure vertically extended as shown in FIG. 4.

In the anti-surge valve 100 according to various embodiments of the present invention, the side wall 132 of the valve cup 130 is formed to have a sectional shape concave toward the center of the valve along the entire circumference thereof, so that the side portion 122 of the diaphragm 120, vertically extended in the valve, can be deformed toward the center of the valve while being adhered closely to the outer surface of the side wall 132 of the valve cup 130.

In this case, the side wall 132 of the valve cup 130 may be formed to have an arc sectional shape recessed toward the center of the valve in the shape of a curved line, so that the side portion 122 of the diaphragm 120 can be gently curved in an ‘S’ shape on the section thereof.

In a case where the side wall 132 of the valve cup 130 is formed in the arc sectional shape so that the outer surface of the side wall 132 of the valve cup 130 is formed in a concave curved line, the side portion 122 of the diaphragm 120, adhered closely to the outer surface of the side wall 132 of the valve cup 130 is also gently curved to have the arc sectional shape. Particularly, as shown in FIG. 5, a portion immediately inside from the edge portion 123 of the diaphragm 120 is curved downward in the state in which the valve is opened, but has a shape curved while forming an approximately circular shape with a large curvature.

In the anti-surge valve 100 according to various embodiments of the present invention, the diaphragm 120 can be deformed in a curved shape without being suddenly curved, as compared with the conventional valve in which a specific portion of the diaphragm is suddenly curved. Accordingly, although the valve is opened, the stress concentration at a specific portion of the diaphragm can be minimized, and it is possible to prevent the excessive deformation of the diaphragm, which causes damage (tear) in the conventional valve.

Further, in a case where the vertical stroke of the valve cup 130 and the diaphragm 120, which vertically move according to the pressure state in the pressure chamber 116, is reduced, the stress concentration can be minimized under the same back pressure condition as compared with the conventional valve. For example, in a case where the stroke of the valve cup and the diaphragm, which can maximally move in the same configuration except the shape of the valve cup, is reduced from 8mm to 6mm as compare with the conventional valve, the stress applied to the same portion of the diaphragm can be relatively reduced under the same back pressure condition after the valve is opened.

Here, the vertical stroke of the valve cup 130 and the diaphragm 120 means a maximum moving distance until the valve cup 130 and the diaphragm 120 cannot move upward any more as the upper plate 141 contacts an inner surface of the cover 111 from the state in which the valve cup 130 and the diaphragm 120 close the air outlet 114 as shown in FIG. 4.

To describe effects according to the configuration of the present invention, the inventor performed stress analysis on the valve according to the present invention and the conventional valve, and confirmed that stress was reduced in the valve of the present invention. The result is shown in the following Table 1.

The stress analysis was performed on the conventional valve and the valve of the present invention, which have the same thickness of 0.6 mm. It was assumed that the conventional valve and the valve of the present invention had the same specification except the shape of the valve cup 130 and the stroke of the valve cup 130, which can maximally move, and the back pressure applied to the bottom surface of the diaphragm 120 also had the same condition.

TABLE 1

| | | Comparative | | |
|---|---|---|---|---|
| | | example | Example 1 | Example 2 |
| Anti-surge condition | | (stroke 8 mm) | (stroke 8 mm) | (stroke 6 mm) |
| Before | Back pressure | 0.89 MPa | 1.19 MPa | 1.19 MPa |
| operation | 1.22 bar | | | |
| After | Back pressure | 1.60 MPa | 1.52 MPa | 1.16 MPa |
| operation | 0.64 bar | (reference) | (5.0%↓) | (27.5%↓) |

In the analysis result, the stress (MPa) represents one at portion designated by circle ‘B’ of FIG. 5. Comparative example is a conventional valve in which the shape of the side wall of the valve cup has a planar structure vertically extended from the bottom portion of the valve cup. Embodiment 1 is a valve of the present invention, in which the side wall 132 of the valve cup 130 is formed in an arc sectional shape. Example 2 is a valve of the present invention, in which the side wall 132 of the valve cup 130 is formed in an arc sectional shape, and the stroke is reduced (stroke 6 mm→8 mm) as compared with the conventional valve.

First, in the state of a stroke of 0mm that is a state before the valve operates, i.e., a state before the valve cup 130 and the diaphragm 120 close the air outlet 114, the stress in the valves of the present invention (Embodiments 1 and 2) is shown greater than that of the conventional valve (Comparative example) under the same back pressure of 1.22 bar. However, after the valve operates (moves to the stroke) the stress in the valves of the present invention is reduced as compared with the conventional valve.

Further, when comparing Example 1 in which the side wall 132 of the valve cup 130 is formed in the arc sectional shape with Example 2 in which the side wall 132 of the valve cup 130 is formed in the arc sectional shape, and the stroke is reduced as compared with the conventional valve, the reduction in stress concentration in Example 2 may be superior to that in Example 1.

As described above, in the anti-surface valve according to the present invention, the shape of the side wall of the valve cup is changed into a curved shape having the arc sectional shape, so that it is possible to reduce the stress concentration on a specific portion of the diaphragm. Accordingly, it is possible to prevent damage of the diaphragm and to improve durability of the valve.

As a result, it is possible to solve a problem in that the power of the engine becomes deficient due to the damage of the diaphragm during driving of the vehicle.

For convenience in explanation and accurate definition in the appended claims, the terms upper or lower, front, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An anti-surge valve for a vehicle, comprising:
a diaphragm that partitions an internal space formed by a valve body and a cover into spaces in which a pressure chamber connected to a connection port, an air inlet and an air outlet are formed, respectively;
a valve cup mounted to the diaphragm;
a coupling member that fixes the diaphragm and the valve cup; and
a spring elastically supporting the diaphragm in the pressure chamber,
wherein a side wall of the valve cup has a concave cross-sectional shape along the entire circumference thereof so that a side portion of the diaphragm deforms toward the center of the valve while being adhered closely to an outer surface of the side wall of the valve cup in a state in which an edge portion of the diaphragm is fixed by the valve body and the cover.

2. The anti-surge valve of claim 1, wherein the outer surface of the side wall of the valve cup is formed to have a curved surface concavely recessed toward the center of the valve.

3. The anti-surge valve of claim 1, wherein the side wall of the valve cup has an arc sectional shape.

4. The anti-surge valve of claim 2, wherein the side wall of the valve cup has an arc sectional shape.
